(19) United States
(12) Patent Application Publication
(10) Pub. No.: US 2008/0050204 A1
(43) Pub. Date: Feb. 28, 2008

(54) Adjustable Document File Binding Device

(75) Inventor: Yimwai Yau, Shenzhen (CN)

Correspondence Address: Raymond Y Chan, 108 N Ynez Avenue Suite 128, Monterey Park, CA, 91754, US

(73) Assignee: Shenzhen Wang Ling Science and Technology Development Co., Ltd.

(21) Appl. No.: 11/664,308

(22) PCT Filed: Sep. 22, 2005
(86) PCT No.: PCT/CN05/01541

§ 371 Date: Mar. 29, 2007

(30) Foreign Application Priority Data
Sep. 30, 2004 (CN) 200410051695.2

(51) Int. Cl. B42B 5/10

(52) U.S. Cl. 412/39

(57) ABSTRACT

An adjustable document file binding device includes a binding seat and at least one binding element, wherein the binding element is slidably mounted in the binding seat to form a space for holding files by fasteners. The binding seat is a rectangular frame constituted by a bottom wall, a rear wall perpendicular to the bottom wall and two side walls at edges of the bottom wall and the rear wall, which opens in two directions. The binding element is a U-shape body corresponding to the binding seat. One or plurals of retractable and detachable connectors are mounted between the binding seat and the binding elements for binding loose leaves. When two binding elements are used, the binding device forms at least two spaces for receiving files. Therefore, the device is adapted to bind loose leaves and other files concurrently.

### BACKGROUND OF THE PRESENT INVENTION

1. Field of Invention

The present invention relates to office and school supplies, and more particularly to an adjustable space for document storage and an adjustable document file binding device for loose leaves or other files.

2. Description of Related Arts

Document equipments, such as cell phone and PDA are widely used in people's daily live, but people still need to look up the paper document such as diagrams, pictures, and notes. It is necessary to bring the file folders, notebooks, and other different document files at all times. Accordingly, all these documents have different formats and/or sizes. For example, some loose leaves or documents contain binding holes for a binder binding thereto. However, different binders have different binding-hole structures. In addition, some certificates or pictures cannot be bound in the binder because it is improper to make the binding holes on such certificates or pictures. How to carry documents of different formats and different binding styles in one device is still not solved. People have to use briefcases to carry all documents and it is very inconvenient.

### SUMMARY OF THE PRESENT INVENTION

To solve this problem, the present invention provides an adjustable file binding device to carry and hold loose leaves or bound document. This device can also adjust using space and adapt to different kinds of folders.

A major object of this present invention is to provide an adjustable file binding device, which comprises a binding seat and at least one binding element, wherein the binding element opening inward is slidably fixed in the binding seat to form a space for file, and after regulating these components can be fixed together in place by some fasten means.

The binding seat is a rectangular frame constituted by a bottom wall, a rear wall perpendicular to the bottom wall and two side walls at the ends of the bottom wall and the rear wall, with through openings. The two side walls comprise a plurality of longitudinal elongated slots for adjustment. The bottom wall comprises a plurality of through openings, connection holes for connecting with the cover, and adjustable elongated holes. The rear wall comprises a plurality of longitudinal elongated slots and spare holes for the loose leaf connectors.

The binding element is a U-shape groove element corresponding to the binding seat. It comprises a plurality of connection holes on its two short side walls corresponding to the longitudinal elongated slots on the side walls of the binding seat. On its long side wall, it comprises a plurality of elongated holes and square holes corresponding to the elongated holes and square holes on the rear wall of the binding seat.

Pluralities of adjustable and removable loose leaf connectors are mounted between the binding seat and binding elements through these elongate slots and square holes.

The loose leaf connecter is constituted by a column element and a tubular element. The column element comprises two columns with different diameters, and the column with the smaller diameter is movably plugged into the inner opening of the tubular element. A spring is provided inside of the inner opening of the tubular element. Both the column element and the tubular element comprise a small square connection head on another end. These two square connection heads can be plugged into the square hole on the rear wall of the binding seat and the square hole on the binding element relatively. Or the two square heads can be plugged into the longitudinal elongate slot on the rear wall of the binding seat and the longitudinal elongate slot on the binding element so the loose leaf connector can slide along the slots.

The bottom wall of the binding seat comprises one pair or a plurality pairs of loose leaf connector bases for holding the loose leaf connectors, each base comprises a square hole corresponding to the square head of the loose leaf connector.

Two binding elements are mounted in the opening of the bind seat with the same or opposite direction. By sliding one or both binding elements, two binding spaces for loose leaf document or bound document are formed.

An adjustable connection board for connecting with the cover is mounted on the bottom wall of the binding seat. The connection board comprises two movable boards which are in a same plane. The two boards comprise connection holes corresponding to the connection holes and adjustable elongated slots on the bottom wall of the binding seat. One board can be moved to adjust the width, and be fastened with the binding seat by fasten means through the elongated slots on the connection board and the bottom board of the binding seat.

The present invention solved the problem of holding files of different formats and binding styles in one file holder. Because the binding device of the present invention can be adjusted in the width direction of the files, to adjust and separate the receiving space, it can be used in different holding manners: holding loose leaves, holding bound files, or holding both loose leaves and bound files in separate spaces. The present invention is compatible with current using file folders, and is convenient to use in people's daily life.

### BRIEF DESCRIPTION OF THE DRAWINGS

FIG. 1 is a perspective view of an adjustable document file binding device according to a preferred embodiment of the present invention, wherein FIG. 1A illustrates the operating status when the loose leaf connecters are in use, FIG. 1B illustrates the fixed status when the loose leaf connecters are in use, wherein FIG. 1C illustrates the operating status when the loose leaf connecters are not in use, wherein FIG. 1D illustrates the fixed status when the loose leaf connecters are not in use.

FIG. 2 is a perspective view of the binding seat.

FIG. 3 is a perspective view of the binding element, wherein FIG. 3A illustrates using one binding element and FIG. 3B illustrates using two binding elements.

FIG. 4 is a perspective view of the loose leaf connector, wherein FIG. 4A is the decomposition view of the loose leaf connector and FIG. 4B is the sectional view of the loose leaf connector.

FIG. 5 is a perspective view of the preferred embodiment for holding loose leaves and other files with separate spaces, wherein FIG. 5A illustrates the separate spaces formed by the binding elements mounted in a same direction and FIG. 5B illustrates the separate spaces formed by the binding elements mounted in opposite directions.

FIG. 6 is a perspective view of the connection of the preferred embodiment with the cover, wherein FIG. 6A illustrates the connection status before the connection board is adjusted, FIG. 6B illustrates the connection status after the connection board is adjusted, and FIG. 6C is the top view of the connection board.

FIG. 7 is a perspective view of the preferred embodiment using in a file folder, wherein FIG. 7A illustrates the status before the connection board is adjusted and FIG. 7B illustrates the status after the connection board is adjusted.

### DETAILED DESCRIPTION OF THE PREFERRED EMBODIMENT

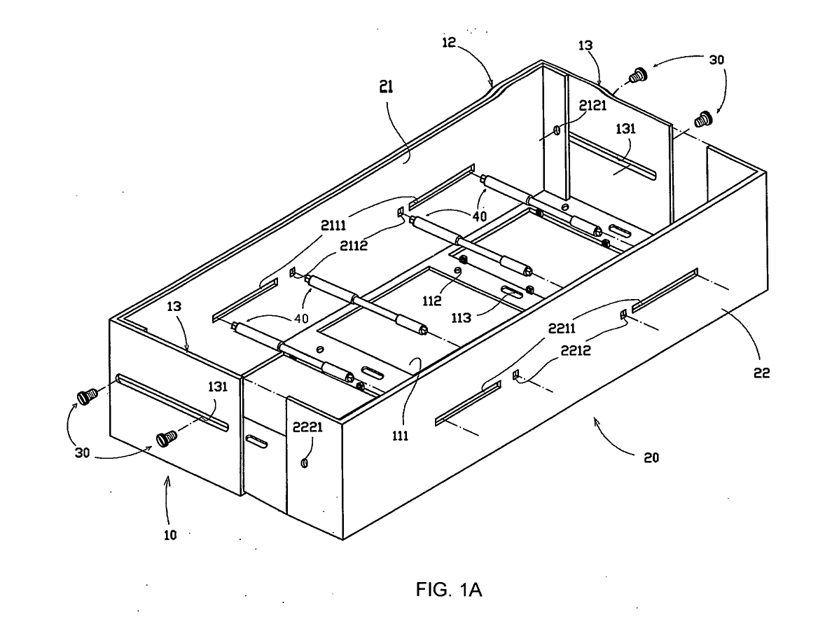

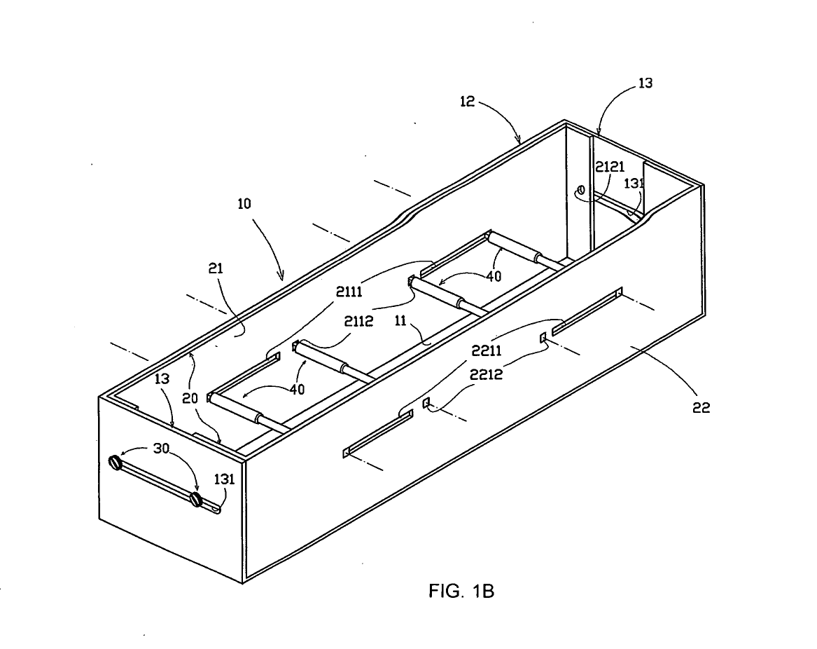

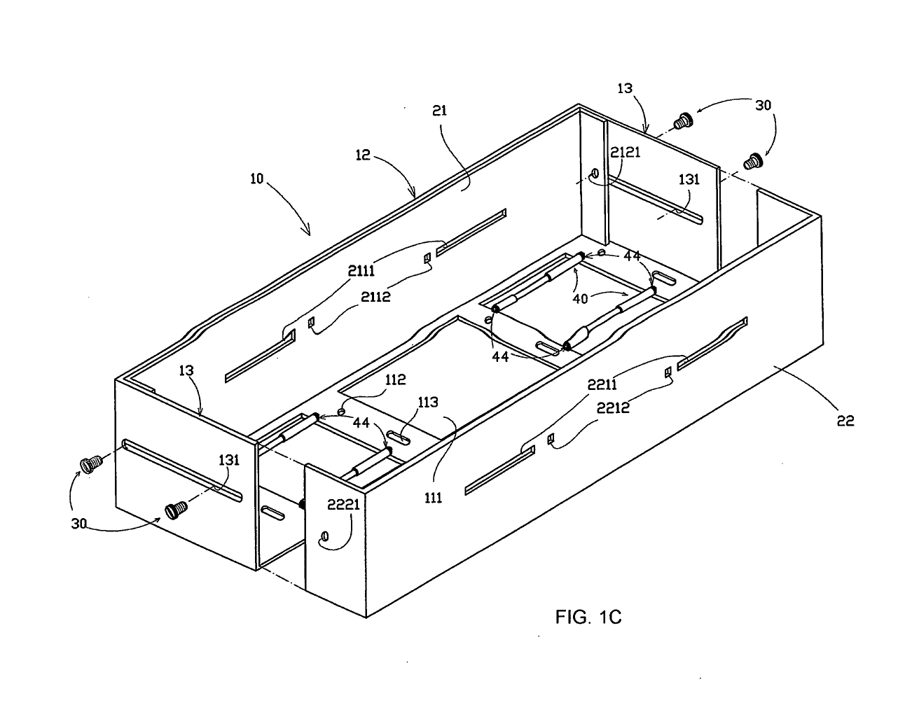

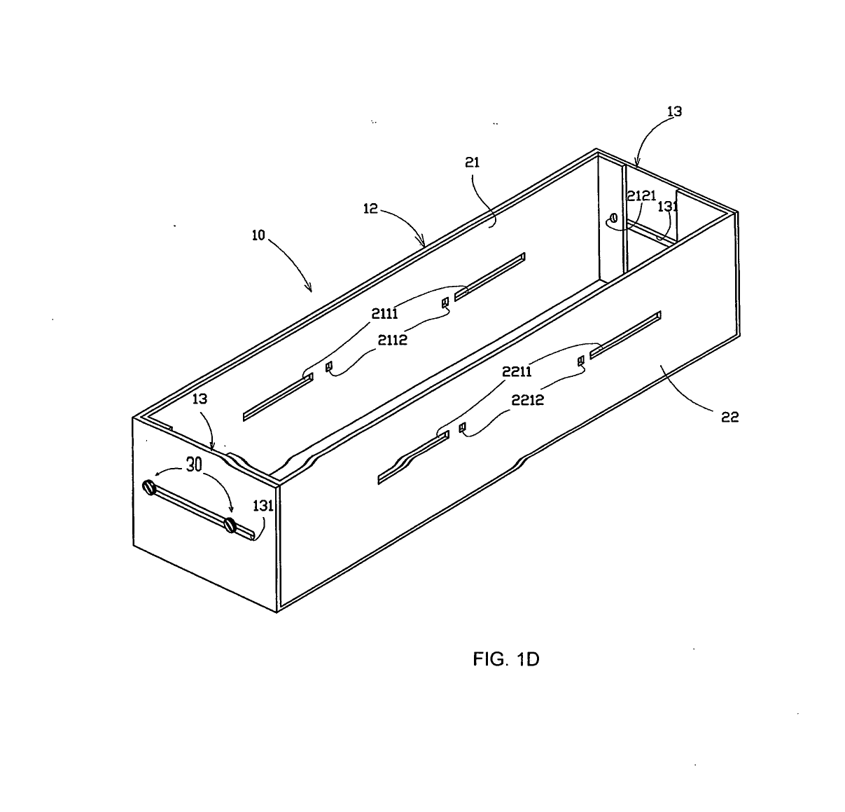

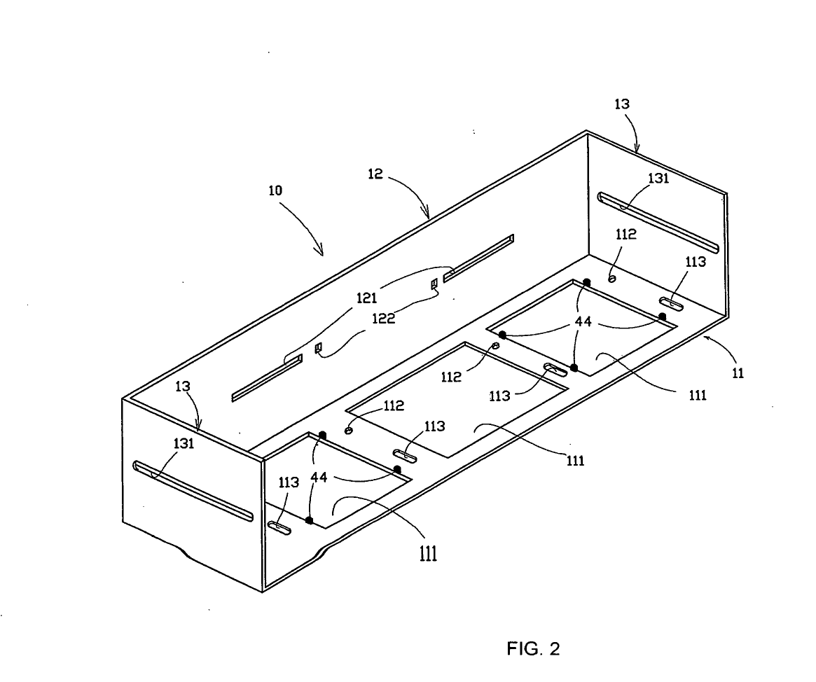

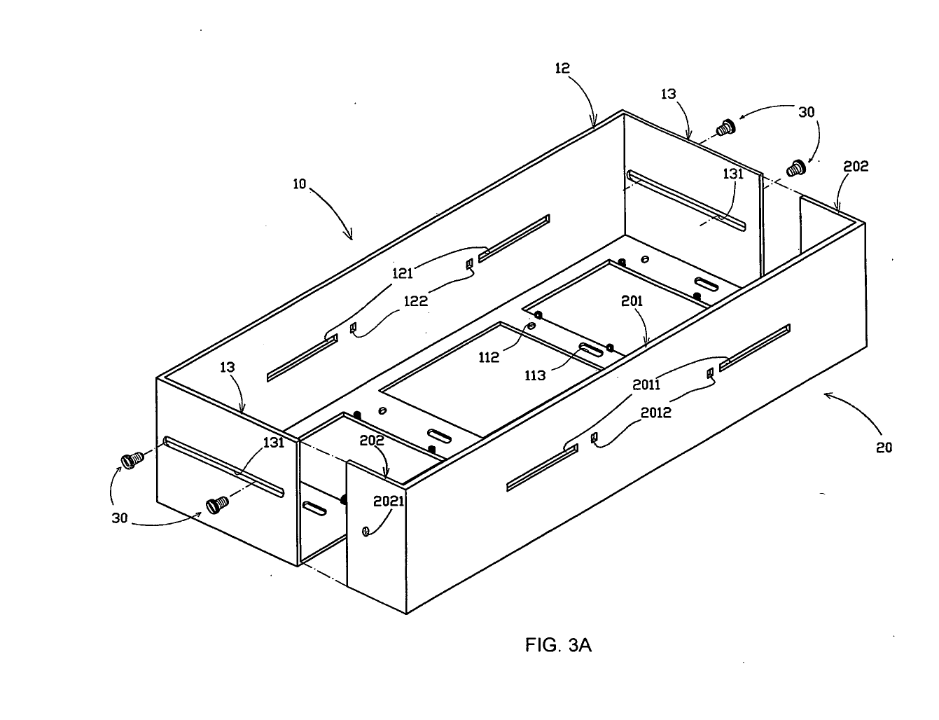

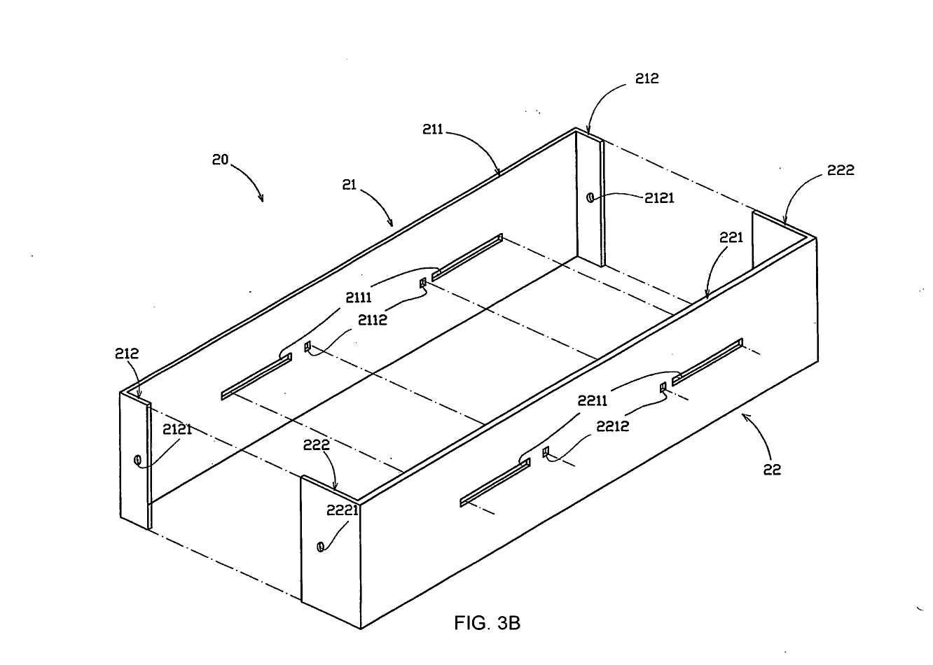

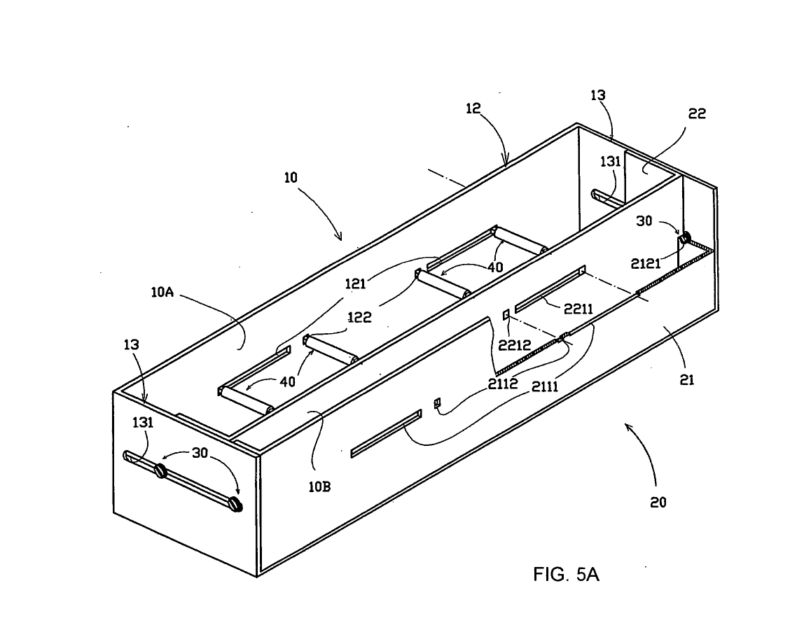

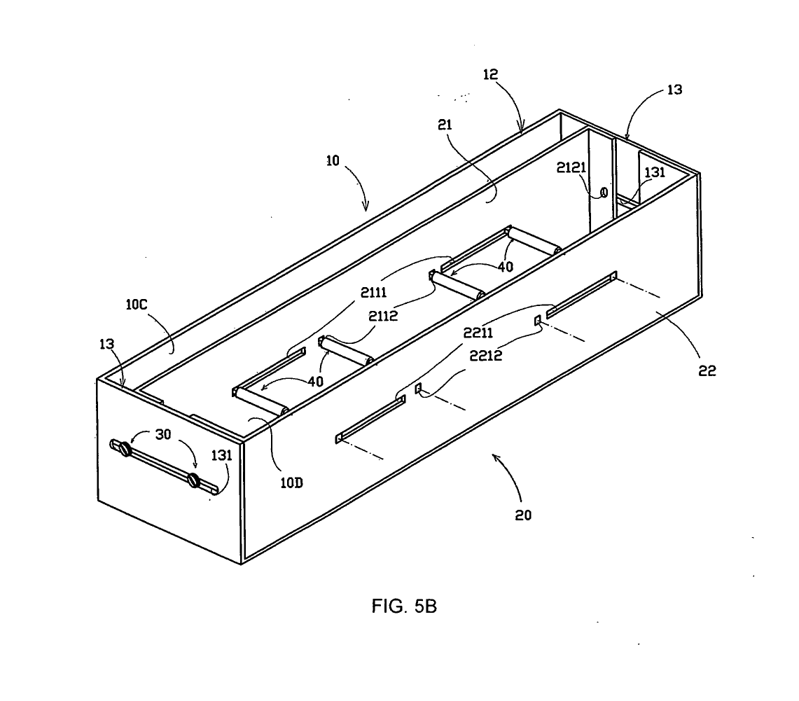

Referring to FIG. 1A, an adjustable document file binding device of the present invention comprises a binding seat 10 and at least a binding element 20. In a preferred embodiment, the device comprises a binding seat 10 and two binding elements 21 and 22. Referring to FIG. 2, the binding seat 10 is a rectangular frame constituted by a bottom wall 11, a rear wall 12 perpendicularly extended to the bottom wall 11 and two side walls 13 extended at the two opposed edges of the bottom wall and the rear wall. The front side and the top side of the frame are open for receiving the files and positioning binding elements 20 respectively. Each of the side walls 13 contains a plurality of longitudinal elongated slots 131 for adjusting the position of the binding elements 20. The bottom wall 11 of the binding seat 10 contains a plurality of through openings 111 for reducing the weight. Next to the sides of the through openings 111 the bottom wall 11, the bottom wall 11 provides a plurality of connection holes 112 for connecting with the cover 60, and adjustable elongated holes 113. The rear wall 12 contains a plurality of longitudinal elongated grooves 121 and square holes 122 for positioning the loose leaf connectors. FIG. 3B illustrates the structure of the binding element 20. Each element 21, 22 comprises a long side wall 211, 221, and two short side walls 212, 222 which are on the two opposed edges of the long side wall 21, 22 and perpendicular to it to form a U-shape groove element corresponding to the binding seat. The widths of the two short side walls 212 and 222 can be different to separate different space in the binding seat 10. The binding element 20 also comprises a plurality of connection holes 2121, 2221 on its two short side walls 212, 222 corresponding to the longitudinal elongated slots 131 on the side walls 13 of the binding seat 10. On its long side wall 211, 221, it comprises a plurality of elongated holes 2111, 2211 and square holes 2112, 2212 corresponding to the elongated grooves 121 and square holes 122 on the rear wall 12 of the binding seat 10. Referring to FIGS. 1A to 1D, the binding element 20 is mounted in the binding seat 10. In an alternative embodiment only one binding element 20 is used, the binding element 20 is mounted facing inside of the binding seat 10. In the second alternative embodiment, two binding elements 20 are mounted facing each other or facing the same direction in the binding seat 10. The binding elements 20 can be slid in the binding seat 10 to adjust the two spaces for different formats of files. FIG. 5A and FIG. 5B illustrate the separate spaces formed by the binding elements mounted in a same direction or in opposite direction. Referring to FIG. 5A, the separate spaces are formed by the binding elements 20 mounted in the same direction. The space 10A can hold loose leaf files with holes. The space 10B can hold loose leaf files without holes. FIG. 5B illustrates the separate spaces formed by the binding elements mounted in opposite directions. The space 10C can hold other files without holes. The space 10D can hold loose leaf files with holes. When the binding elements 20 are adjusted in position, a plurality of bolts 30 fasten the binding seat 10 and the binding elements 21, 22 through the longitudinal elongated slots 131 on the side walls 13 of the binding seat 10, and the connection holes 2121, 2221 on the two short side walls 212, 222 of the binding elements 21, 22.

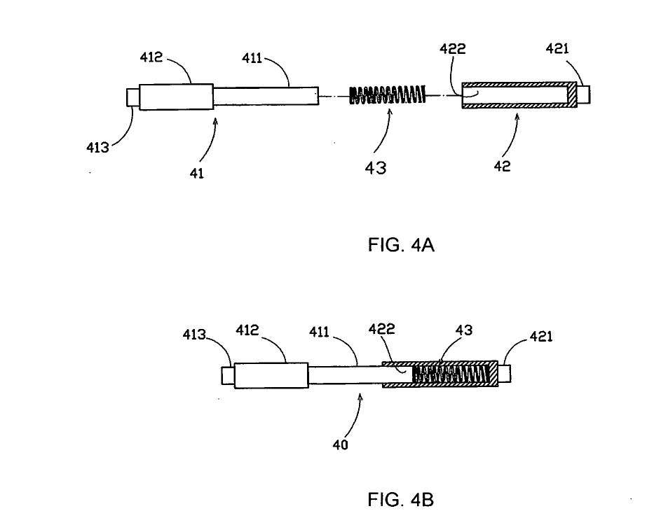

Referring to FIG. 3A, in order to hold loose leaf files, one or a plurality of adjustable and removable loose leaf connectors 40 are mounted between the binding seat 10 and the binding elements 21, 22 through the elongated grooves 121 and square holes 122 on the binding seat 10, and the elongated slots 2011 and the square holes 2012 on the binding elements 21, 22. Referring to FIG. 4, the loose leaf connection 40 comprises a column element 41 and a tubular element 42. The column element 41 comprises two columns 411, 412 with different diameters. The column with smaller diameter 411 is movably plugged into the inner opening 422 of the tubular element 42 in an axially slidable manner. The tubular element 42 provides a spring 43 in the inner opening 42 to limit the movement of the column element 41. The column element 41 comprises a square connection head 413 in relatively small dimension. The tubular element 42 comprises a square connection head 421 in relatively small dimension at the close end. These two heads 413, 421 are plugged into the square holes 122 on the rear wall 12 of the binding seat 10 and the square holes 2112, 2212 on the binding element 20 respectively, or are plugged into the longitudinal elongated grooves 121 on the rear wall 12 of the binding seat 10 and the longitudinal elongated slots 2111, 2211 on the binding element 20 slidably according to different hole distance of loose leaves. Push the column element 41 towards the tubular element 42 to adjustably reduce the length of the connector 40 when the loose leaves need to be removed. In other words, the column element 41 is slidably engaged with the tubular element 42 to selectively adjust the length between the free ends of the column element 41 and the tubular element 42 via the spring 43. The loose leaf connector 40 can be removed to hold files other than loose leaves. As illustrated in FIG. 2, the bottom wall 11 of the binding seat 10 comprises a pair or a plurality pairs of loose leaf connector bases 44 on the sides of the openings 111 for holding the loose leaf connectors 40, each base comprises a square hole corresponding to the square head 413, 421 of the loose leaf connector 40. The removed loose leaf connector 40 can be positioned in the loose leaf connector base 44.

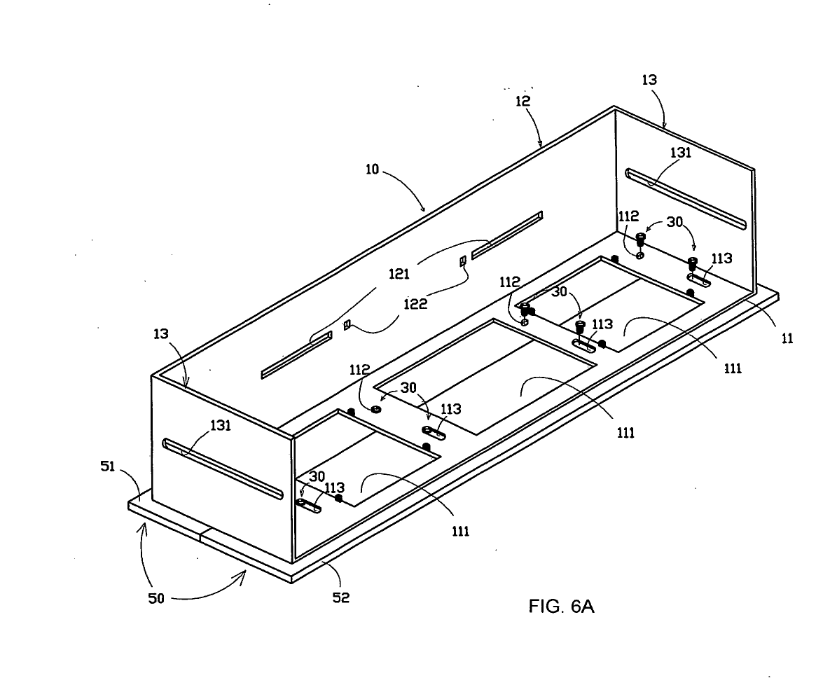

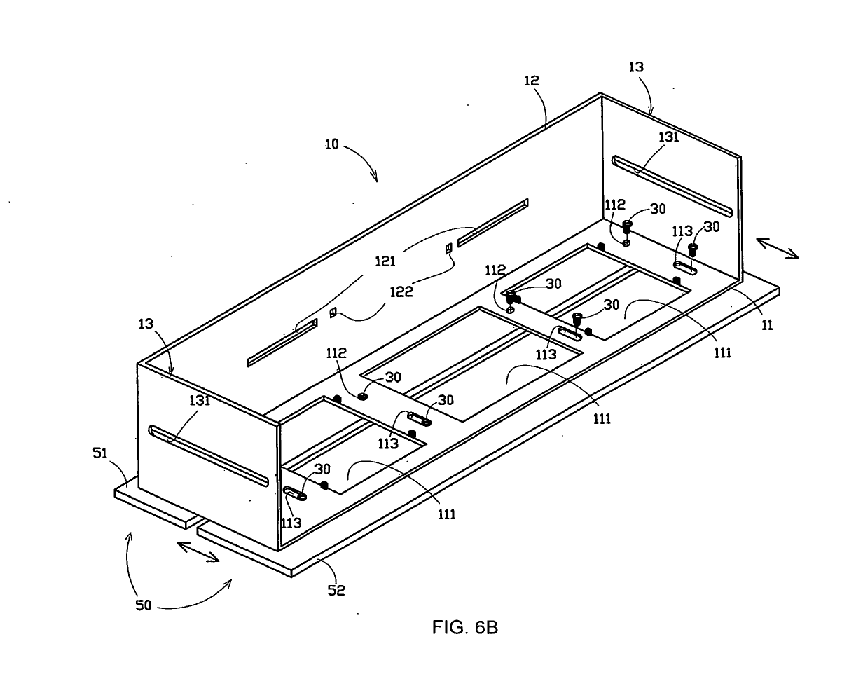

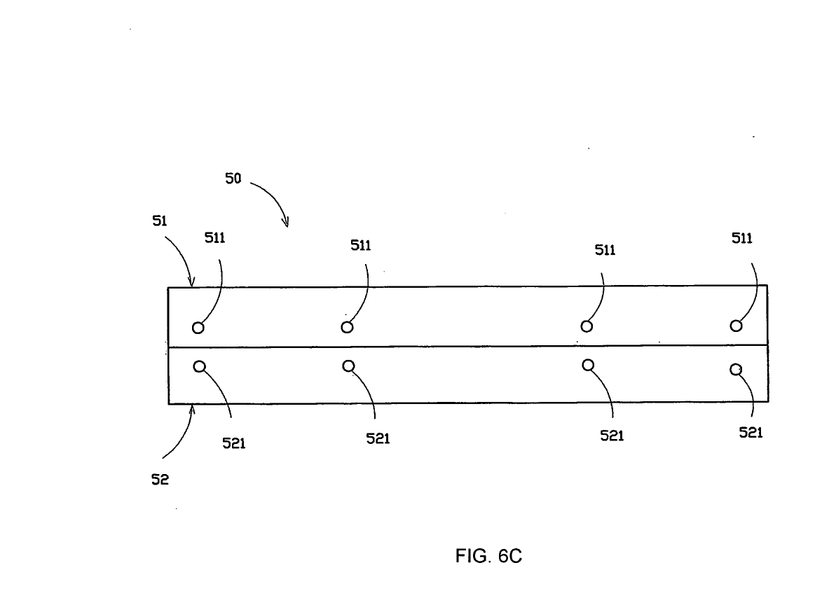

In order to cooperate with current using file folders, the device also comprises an adjustable connection board 50 for connecting with the cover 60 which is mounted on the bottom wall 11 of the binding seat 10, as illustrated in FIG. 6. Referring to FIG. 6C, the connection board 50 comprises two movable boards 51, 52 which are in a same plane. The two boards comprise connection holes 511, 521 corresponding to the connection holes 112 and adjustable elongated slots 113 on the bottom wall of the binding seat 10. FIG. 6A illustrates the connection status before the connection board is adjusted. Referring to FIG. 6B, one board can be moved to adjust the width, and be fastened to the binding seat 10 by fasten means through the elongated slots 113 on the bottom wall 11 and the connection holes 521 on the connection board 50. The length of the elongated slots 113 ensures the adjustment.

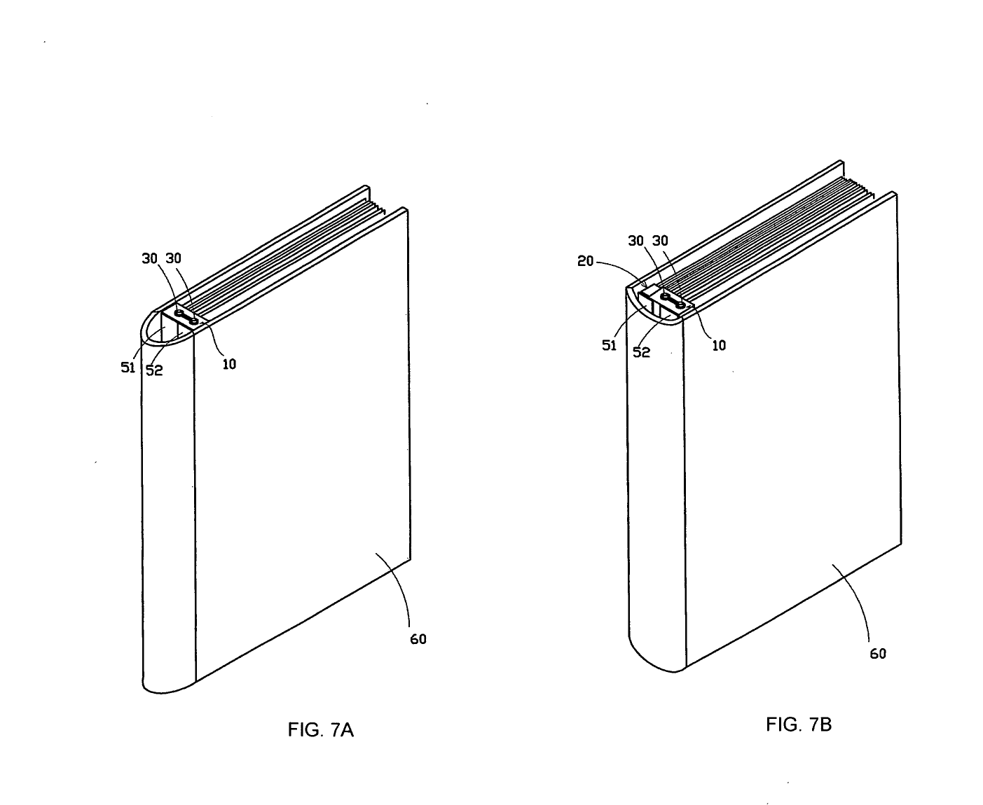

FIG. 7 is a perspective view of the preferred embodiment using in a file folder. FIG. 7A illustrates the status before the connection board 50 is adjusted. In a preferred embodiment, the binding seat 10 and the cover 60 is connected by the connection board 50, fastened by fasten means, preferably using bolts through the connection holes 112, elongated slots 113 on the bottom wall 11 and the connection holes 511, 521 on the connection board 50. Before the adjustment, the center back of the cover 60 is bowed. FIG. 7B illustrates the status after the connection board is adjusted. The center back of the cover 60 is flatter, more files can be contained inside the cover 60, and the shape of the cover is not affected.

1. An adjustable document file binding device, comprising: a binding seat, at least a binding element having an opening and a dimensional space, and a fastener, wherein said binding element is slidably mounted in said binding seat facing towards said opening of said binding element to adjust said dimensional space for fittingly holding files via said fastener.

2. The device, as recited in claim 1, wherein said binding seat comprises a bottom wall, a rear wall perpendicularly extended from said bottom wall, and two side walls extended from said bottom wall to define said opening at edges of said bottom walls and said side walls and to form a rectangular frame, wherein said edge of each of said side walls is shorter than said edge of said rear wall, wherein each of said side walls contains an elongated longitudinal slot for selectively adjusting a position of each of said side walls with respect to said rear wall, wherein said bottom wall contains a plurality of openings, a plurality of connection holes, and a plurality of adjustable elongated slots for connecting with a cover, wherein said rear wall contains a plurality of longitudinal elongated grooves and a plurality of square holes for coupling with said binding element.

3. The device, as recited in claim 1, wherein said binding element is a U-shaped groove element corresponding to the dimension of said binding seat, said binding element containing a plurality of connection holes and square holes on the two short side walls of said binding element corresponding to said longitudinal elongated slots on said side walls of said binding seat.

4. The device, as recited in claim 3, further comprising one or more adjustable and removable loose leaf connector mounted between said binding seat and said binging element through said elongated slots and square holes on said binding seat and said binding element.

5. The device, as recited in claim 4, wherein said loose leaf connector comprises a column element and a tubular element, wherein said column element comprises two columns with different diameters, said column with smaller diameter is movably plugged into a inner opening of said tubular element, wherein said tubular element also comprise a spring inside said inner opening, said column element also comprises a square connection head in relatively small dimension, said tubular element also comprises a square connection head in relatively small dimension at the close end, whereby these two heads are plugged into said square holes on said rear wall of said binding seat and said square holes on said binding element respectively, or are plugged into said longitudinal elongated slots on said rear wall of said binding seat and said longitudinal elongated slots on said binding element slidably.

6. The device, as recited in claim 4, wherein said binding seat further comprises one pair or a plurality of pairs of loose leaf connector bases on said bottom wall for holding said loose leaf connector, wherein said loose leaf connector base comprises a square hole corresponding to said square connection head on said loose leaf connector.

7. The device, as recited in claim 1, wherein said two binding elements are adjustably mounted on said binding seat provides in a same direction or in opposite directions whereby to form two spaces for holding loose leaves or other files.

8. The device, as recited in claim 1, wherein said device also comprises an adjustable connection board mounted on the outside of said bottom wall to connect with a cover, wherein said connection board comprises two movable boards in a same plane, each board comprises a plurality of connection holes corresponding to said connection holes and said adjustable elongated slots on said bottom wall, wherein one board is movable to adjust the width and is able to be fixed with said binding seat through said elongated slots on said bottom wall and said connection board by fasten means.
